(19) United States
(12) Patent Application Publication
(10) Pub. No.: US 2008/0307091 A1
(43) Pub. Date: Dec. 11, 2008

(54) Information processing apparatus, website access permission method

(75) Inventors: Kenji Sakamaki, Kawasaki (JP); Shinya Saka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 12/076,550

(22) Filed: Mar. 19, 2008

(30) Foreign Application Priority Data
Mar. 20, 2007 (JP) 2007-073314

(51) Int. Cl. G06F 15/173

(52) U.S. Cl. 709/225

(57) ABSTRACT

According to an aspect of an embodiment, an information processing apparatus for restricting accesses of websites comprises: a storage unit for storing information of access restricted websites; and a processor for performing a process of access permission comprising the steps of: receiving a request of access to one of the websites from a user; determining whether the requested websites is restricted or not by reference to the stored information of the access restricted websites; warning the user when the request has been made for the access to one of the restricted websites; and permitting the access to said one of the restricted websites upon confirmation of the warning by the user and reporting the access of the restricted websites to an administrator.

### BACKGROUND OF THE INVENTION

1. Field of the Invention

The present invention relates to a filtering technique for restricting access to a Website.

2. Description of the Related Art

Information processing terminals such as personal computers (PCs) are capable of accessing Website content on the Internet so that the users of information processing terminals can view the content. Some of Website content is undesirable. Therefore, it is necessary to restrict access to Websites (uniform resource locators (URLs): addresses on the Web) that contain content decided to be undesirable and released undesirable content.

For such Website access restriction, the following patent documents are present: Japanese Unexamined Patent Application Publication Nos. 2004-362031, 2003-283549, and 2004-120574, and PCT Japanese Translation Patent Publication No. 2003-532184.

In conventional Website filtering apparatuses, filtering software determines whether content is harmful. However, even Websites that filtering software has blocked because of their harmful content may sometimes be given permission of access. In this case, the administrator must execute complicated exception registration work.

### SUMMARY

According to an aspect of an embodiment, an information processing apparatus for restricting accesses of websites comprises: a storage unit for storing information of access restricted websites; and a processor for performing a process of access permission comprising the steps of: receiving a request of access to one of the websites from a user; determining whether the requested websites is restricted or not by reference to the stored information of the access restricted websites; warning the user when the request has been made for the access to one of the restricted websites; and permitting the access to said one of the restricted websites upon confirmation of the warning by the user and reporting the access of the restricted websites to an administrator.

### BRIEF DESCRIPTION OF THE DRAWINGS

FIG. 1 is a diagram of a personal computer (PC) according to a first embodiment of the invention;

FIG. 2 is a block diagram of the hardware of the PC;

FIG. 3 is an external view of the PC;

FIG. 4 is a diagram showing an example of a local DB;

FIG. 5 is a diagram of an example of a browsing history table;

FIG. 6 is a diagram of an example of an access denying keyword table;

FIG. 7 is a diagram of a dialog screen;

FIG. 8 is a diagram of an access report screen;

FIG. 9 is a diagram of a browsing history check screen;

FIG. 10 is a flowchart of the overall procedure for permitting or restricting access to a Website;

FIG. 11 is a flowchart for a procedure of accessing and filtering a Website;

FIG. 12 is a flowchart for another procedure of accessing and filtering a Website;

FIG. 13 is a flowchart for the procedure of viewing history information;

FIG. 14 is a flowchart for the procedure of restricting access;

FIG. 15 is a diagram of a PC network system according to a second embodiment;

FIG. 16 is a diagram of an example of a local DB according to another embodiment;

FIG. 17 is a diagram of an example of a portable terminal according to another embodiment; and

FIG. 18 is a diagram of an example of a PDA according to another embodiment.

### DESCRIPTION OF THE PREFERRED EMBODIMENTS

### First Embodiment

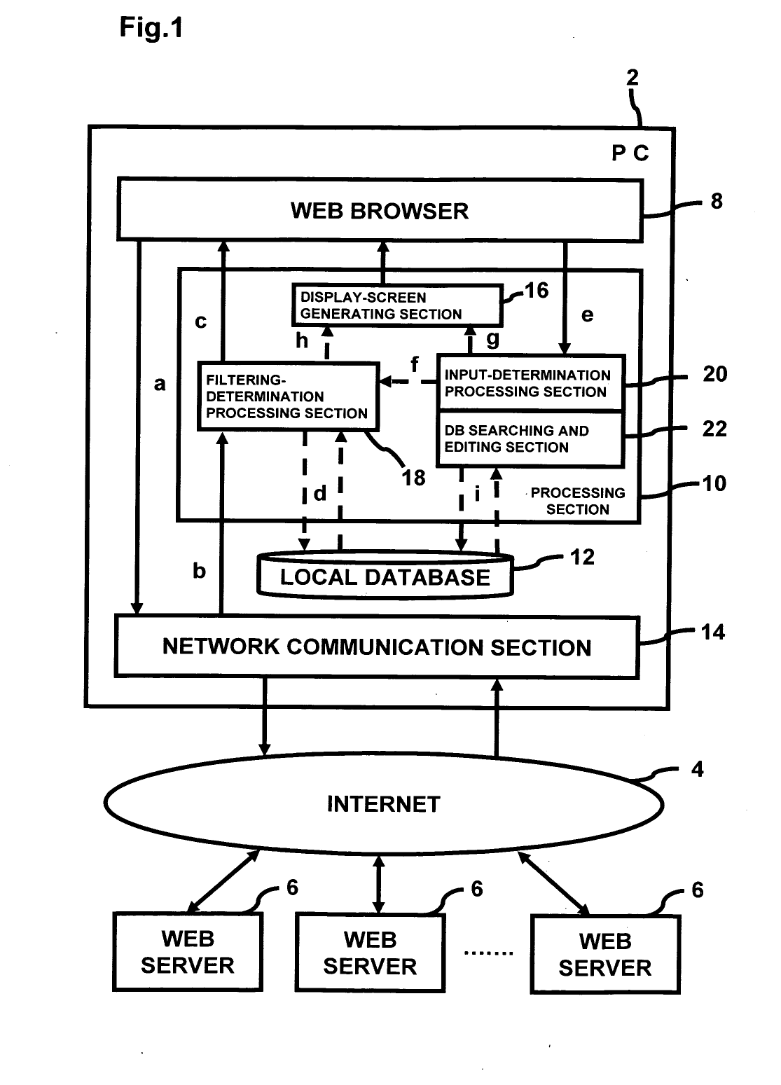

A first embodiment of the invention will be described with reference to FIG. 1. FIG. 1 shows a personal computer according to the first embodiment.

The personal computer (PC) 2 is an example of an apparatus, a method, and a program for filtering Websites, a recording medium in which the filtering program is stored, and a Website filtering system. The PC 2 constitutes a computer system or a user information terminal which provides the user with the opportunity of reconsideration of site viewing without administrator involvement while maintaining filtering effects of the filtering program, thereby allowing the user to view Websites by user's own decision.

The PC 2 does not require receiving means for receiving the reason of access and a determination section for determining whether to permit the access individually according to the reason. Accordingly, the PC 2 prevents complication of the processing structure and improves the effects of restricting undesirable sites.

The PC 2 is a client unit connected to one or a plurality of Web servers 6 via the Internet 4 to allow Web sites set up on the Web servers 6 to be viewed. The Internet 4 is an example of a computer network having a plurality of computers which are information sources.

To achieve the filtering function including generating a dialog screen and a viewing warning message when the user selects a restricted Website, recording or reporting the viewing to the administrator, and checking the access record by the administrator, the PC 2 includes a Web browser 8, a processing section 10, a local database (DB) 12, and a network communication section 14, as shown in FIG. 1.

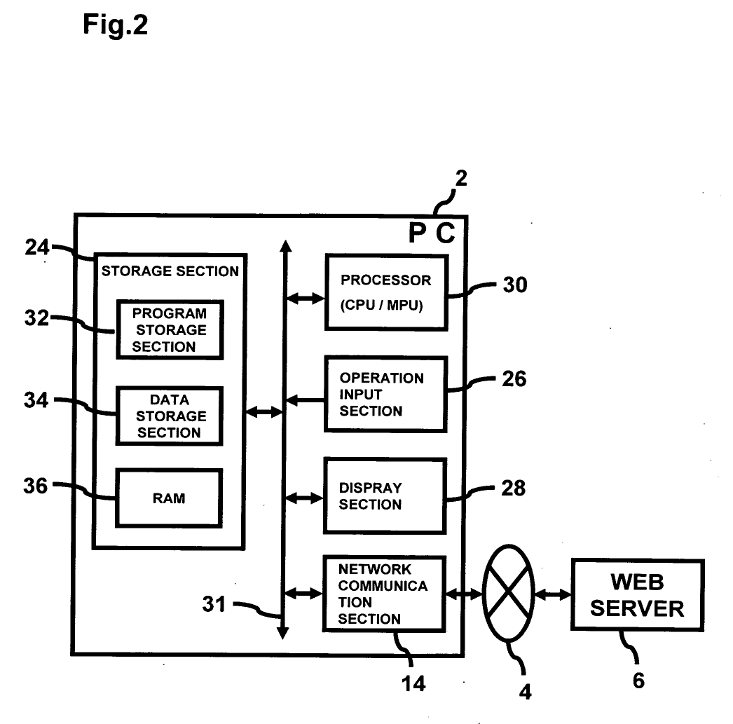

The Web browser 8 is browsing software for browsing the content (the content of data or files) of Websites. The processing section 10 is an operation part generated by execution of a filtering program. The local DB 12 is a file, a file group, or a database system constructed of data in a storage section 24 (see FIG. 2). The network communication section 14 is means for communication or exchange of data with the Websites on the Internet 4. In this embodiment, the network communication section 14 takes charge of exchanging content of the Websites in response to a user request. The network communication section 14 may be configured to communicate with an access point of a wireless local area network (LAN) by radio or communicate with a mobile radio system station or the like.

The processing section 10 is a Web server and includes a display-screen generating section 16, a filtering-determination processing section 18, an input-determination processing section 20, and a database (DB) searching and editing section 22. The display-screen generating section 16 generates, in response to a user's access request, a dialog screen for receiving input for reconsideration of the user's access request and shifting to access. The dialog screen displays a warning message for the user.

The filtering-determination processing section 18 is means for determining from the URL of the Website whether a requested Website is restricted. The result of determination causes the display-screen generating section 16 to generate the dialog screen. The URL of the Website is stored in the local DB 12. The URL is restricted by the administrator as necessary. The restriction is set for each URL.

The input-determination processing section 20 is processing means for determining various inputs including an access request from the user and access restriction from the administrator. The DB searching and editing section 22 searches the data in the local DB 12 and edits search data. The edited data is stored in the local DB 12.

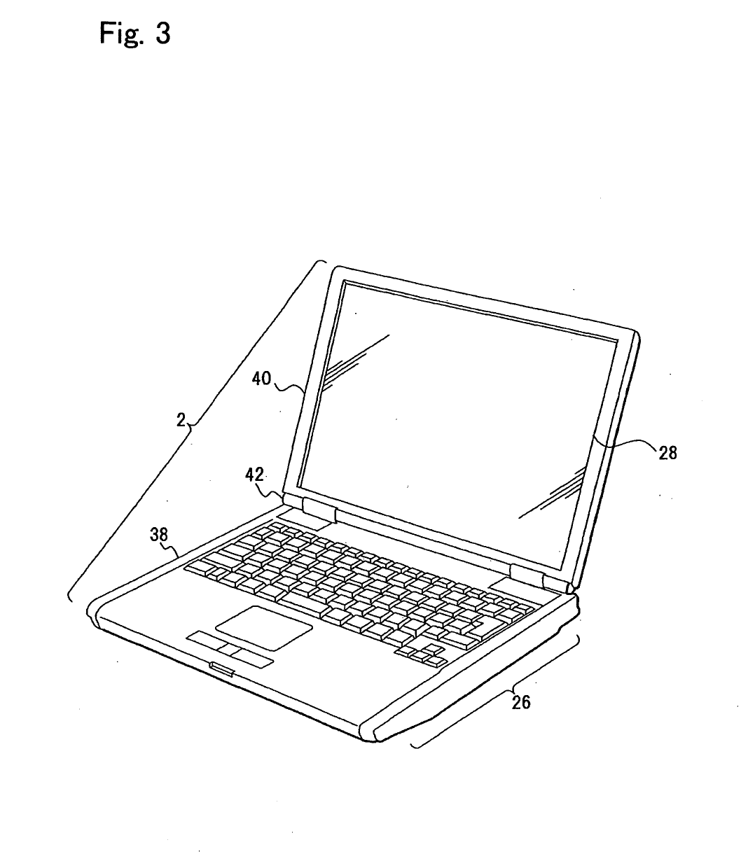

Referring next to FIGS. 2 and 3, the hardware of the PC 2 will be described. FIG. 2 is a block diagram of the hardware of the PC 2, and FIG. 3 is an external view of the PC 2. In FIG. 2, the same components as those of FIG. 1 are given the same reference numerals.

To achieve the above-described filtering function, the PC 2 includes a storage section 24, an operation input section 26, a display section 28, a network communication section 14, and a processor 30. The functional components are connected together by a bus 31. The storage section 24 is a recording medium, which includes a program storage section 32, a data storage section 34 and a random-access memory (RAM) 36. The program storage section 32 is a hard disk, in which an operating system (OS), access restricting software, filtering software which is one example of the invention and so on are stored. The data storage section 34 stores various information to form the local DB 12. The information includes information of Website browsing history, communication history, and report to the administrator. The RAM 36 is a work area, which configures the processing section 10 of the filtering apparatus in the PC 2 together with the processor 30 by execution of a filtering program. The processor 30 is means for executing the OS and application programs, which includes a central processing unit (CPU) or a micro processor unit (MPU) and configures the processing section 10 together with the RAM 36.

The operation input section 26 is an input unit including a keyboard and a mouse. The display section 28 is an output unit including a screen display section such as a liquid crystal display (LCD), which is used to display image date taken from Websites, dialog screens, warnings and so on.

As shown in FIG. 3, for example, the PC 2 has first and second casings 38 and 40, which are opened or closed with a hinge 42. The first casing 38 has the operation input section 26, and the second casing 40 has the display section 28.

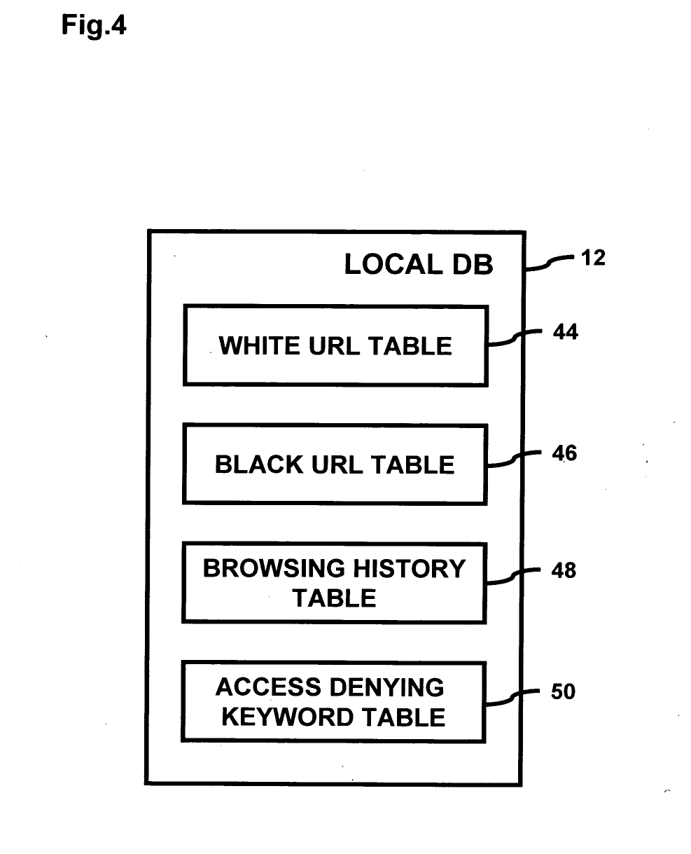

Referring to FIG. 4, the local DB 12 will be described. FIG. 4 is a diagram showing an example of tables in the local DB 12. In FIG. 4, the same components as those of FIG. 1 are given the same reference numerals.

The local DB 12 holds a white URL table 44, a black URL table 46, a browsing history table 48, and an access denying keyword table 50. The white URL table 44 stores the URLs of accessible Websites. The black URL table 46 stores the URLs of inaccessible Websites. Registration to the black URL table 46 causes access restriction. The browsing history table 48 stores the record of the Websites that the user viewed. The access denying keyword table 50 stores keywords for determining whether to block the Website.

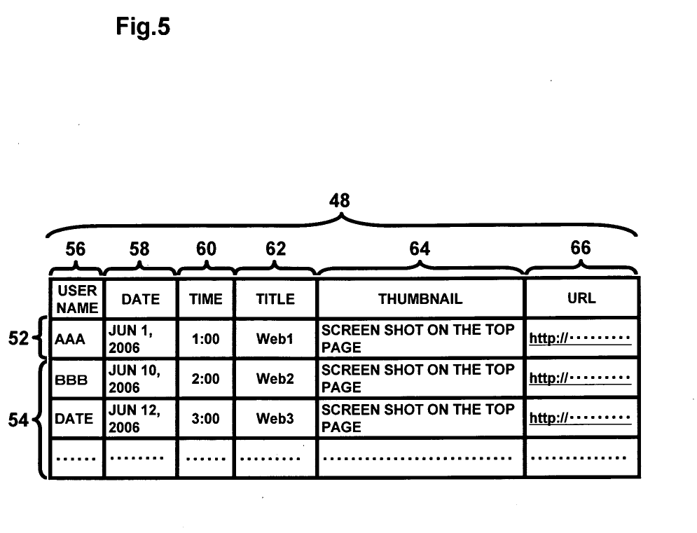

Referring to FIG. 5, the browsing history table 48 will be described. FIG. 5 is a diagram of an example of the browsing history table 48. In FIG. 5, the same components as those of FIG. 1 are given the same reference numerals.

As shown in FIG. 5, the browsing history table 48 has title boxes 52 and information boxes 54. The title boxes 52 provide user name 56, date 58, time 60, title 62, thumbnail 64, and URL 66. The title 62 is title information indicative of Website content. The thumbnail 64 is a sample image indicative of content, such as a screen shot of the top page, which is provided from a Website. The thumbnail 64 is for the user to guide Websites, which generally represents the intention of Websites. The thumbnail 64 is therefore useful information in knowing the characteristics of Websites and as the material for determining whether the site presented by the thumbnail 64 is harmful.

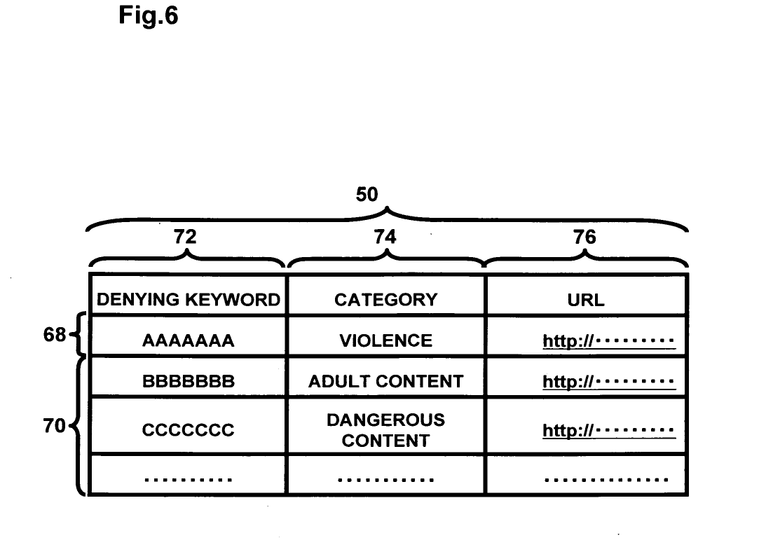

Referring to FIG. 6, the access denying keyword table 50 will be described. FIG. 6 shows an example of the access denying keyword table 50. In FIG. 6, the same components as those of FIG. 1 are given the same reference numerals.

The access denying keyword table 50 has title boxes 68 and information boxes 70. The title boxes 68 provide denying keyword 72, category 74, and URL 76. The denying keyword 72 stores words or the like that are used to determine whether to block access. The category 74 stores the fields or the like in which the words are used.

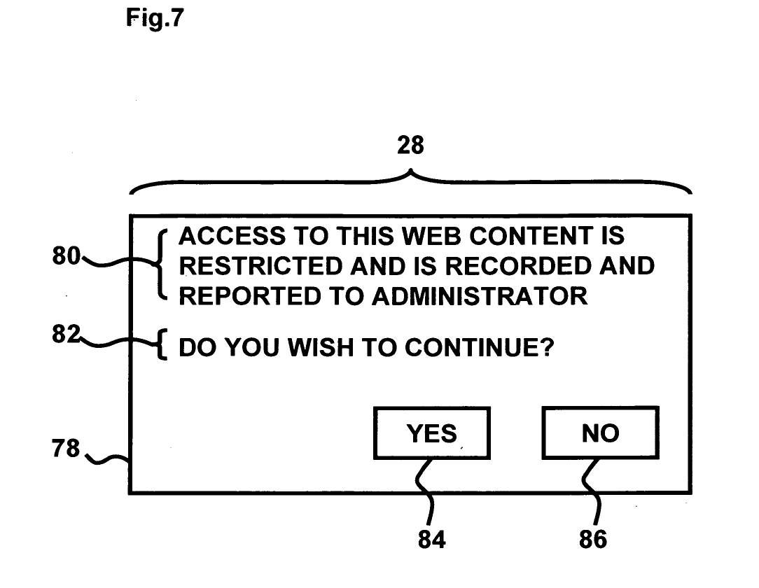

Referring to FIG. 7, a dialog screen and a warning message will be described. FIG. 7 shows a dialog screen. In FIG. 7, the same components as those of FIGS. 2 and 3 are given the same reference numerals.

As shown in FIG. 7, the display section 28 displays a dialog screen 78 in response to an access request to a restricted Website. The dialog screen 78 displays a warning and an inquiry and receives dialog input, on which a warning message 80 and an access inquiry 82 are displayed.

In this case, the warning message 80 is
“Access to this Web content is restricted and is recorded and reported to the administrator.”

The-access inquiry 82 is
“Do you wish to continue?”

There are a YES button 84 indicative of shifting to access and a NO button 86 indicative of denying shifting to access under the access inquiry 82.

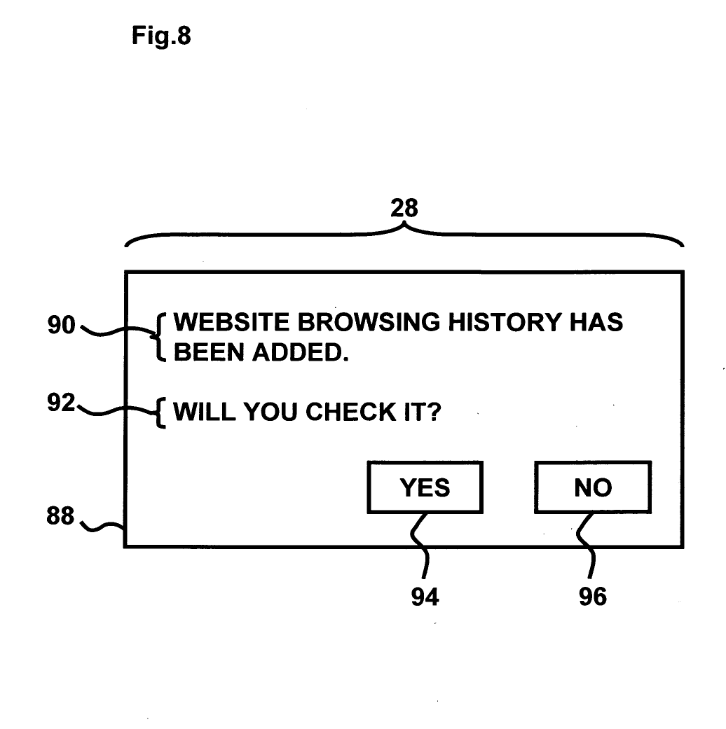

Referring to FIG. 8, an access report screen will be described. FIG. 8 is a diagram of an access report screen. In FIG. 8, the same components as those of FIGS. 2 and 3 are given the same reference numerals.

When the administrator boots up the PC 2, the display section 28 displays a report screen 88, as shown in FIG. 8. The report screen 88 displays a report message 90 and a confirmation inquiry 92. The report screen 88 90 and the confirmation inquiry 92 are as follows:
“A Website browsing history has been added. Will you confirm it?”

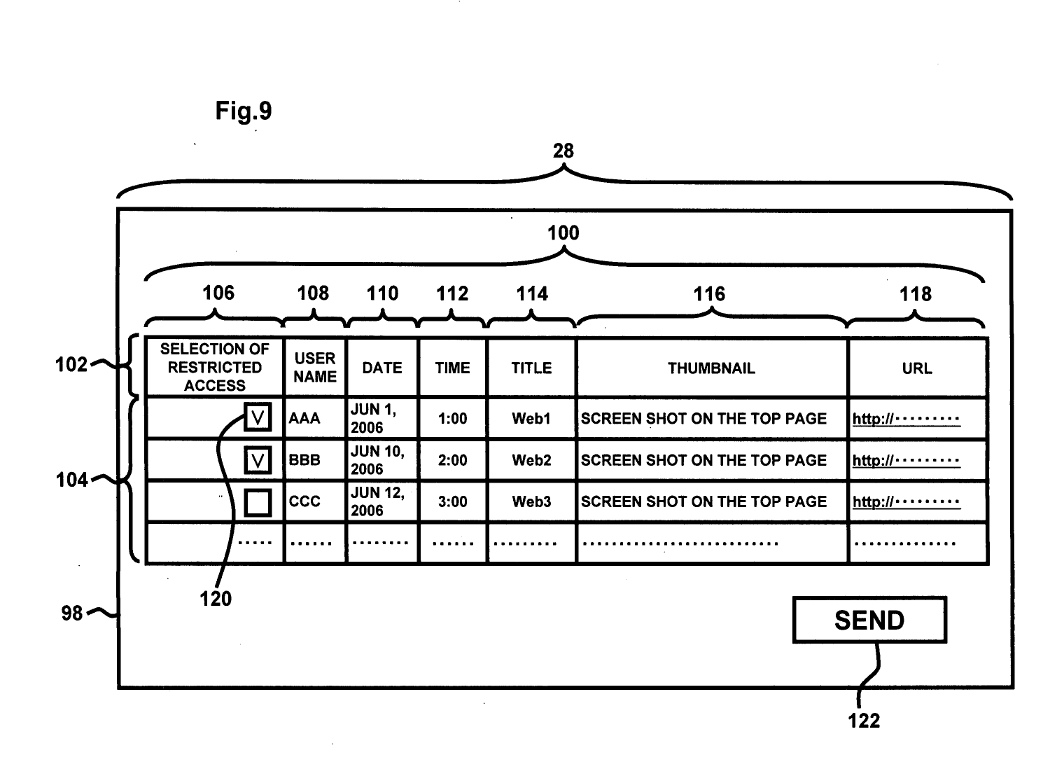

There are a YES button 94 and a No button 96 under the confirmation inquiry 92. When the YES button 94 is clicked on, the screen shifts to a browsing history check screen 98 (see FIG. 9), and when the No button 96 is clicked on, the report screen 88 is canceled.

Referring to FIG. 9, the browsing history check screen 98 will be described. FIG. 9 is a diagram of an example of the browsing history check screen 98. In FIG. 9, the same components as those of FIGS. 2 and 3 are given the same reference numerals.

The display section 28 displays the browsing history check screen 98 for administrator's check of browsing history, as shown in FIG. 9. The browsing history check screen 98 displays the browsing history of the local DB 12 to configure a dialog screen for selection of restricted access.

In this case, the browsing history check screen 98 displays a browsing history list 100, as shown in FIG. 9. The browsing history list 100 has title boxes 102 and information boxes 104. The title boxes 102 provides selection of restricted access 106, user name 108, date 110, time 112, title 114, thumbnail 116, and URL 118. The selection of blocking 106 has check boxes 120 for selecting normally blocking of the URL 118. When the check boxes 120 are checked, a normally blocked URL is selected.

There is a send button 122 under the browsing history list 100. When the send button 122 is clicked on with a cursor, the normally blocked URL is transferred to the black URL table 46, and its blocking is set.

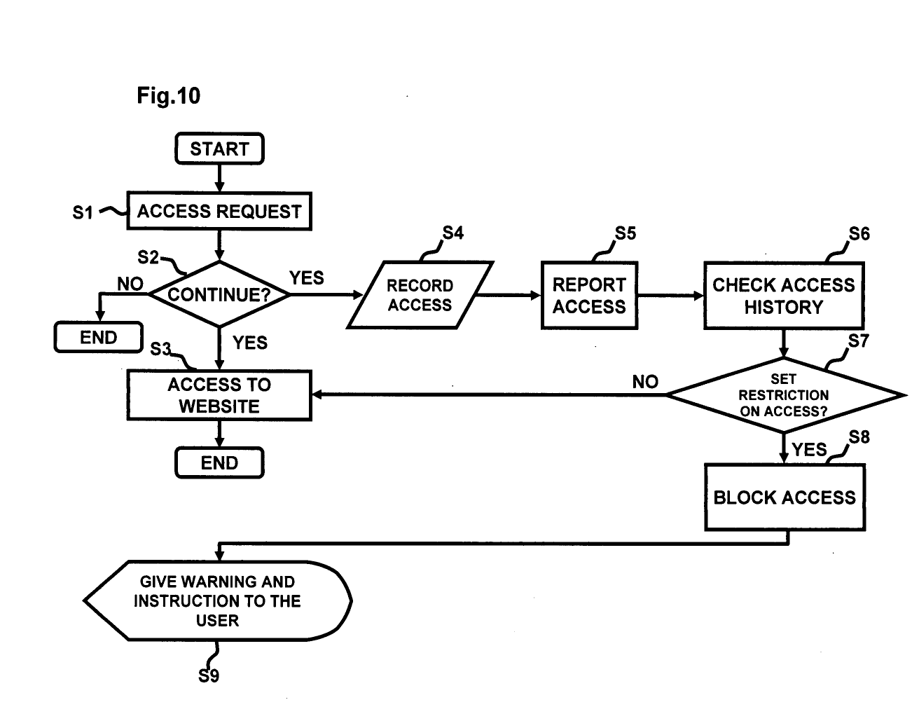

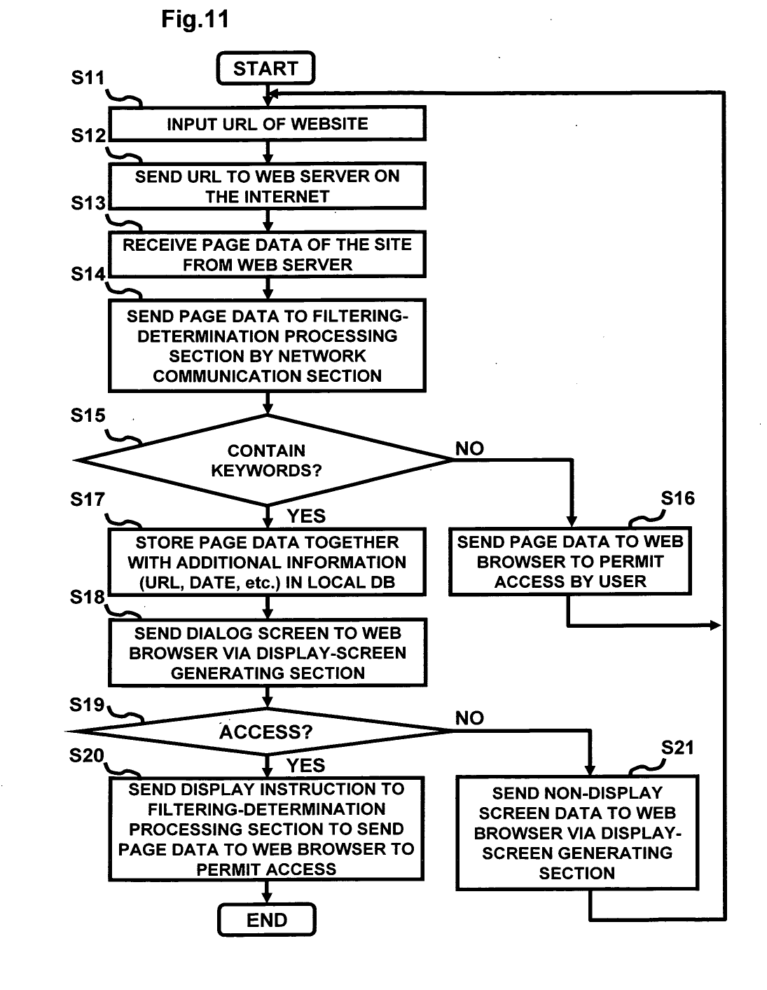

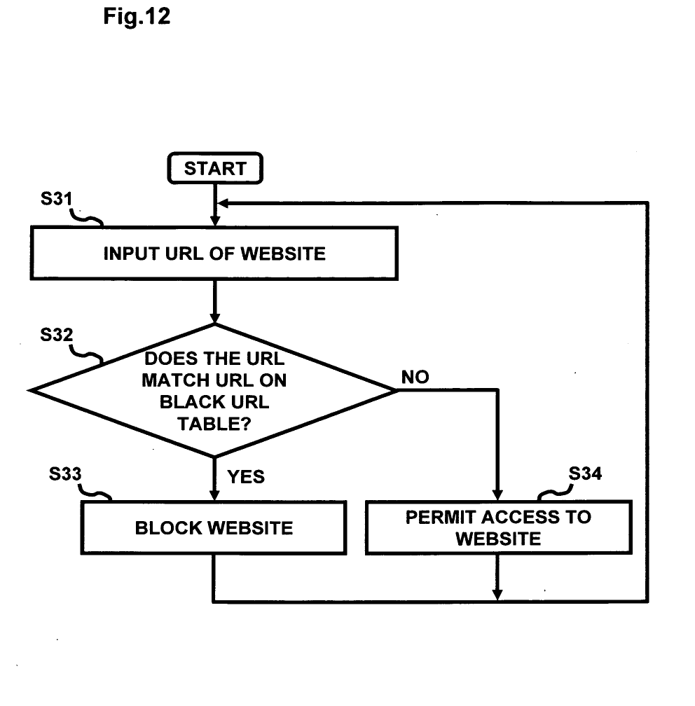

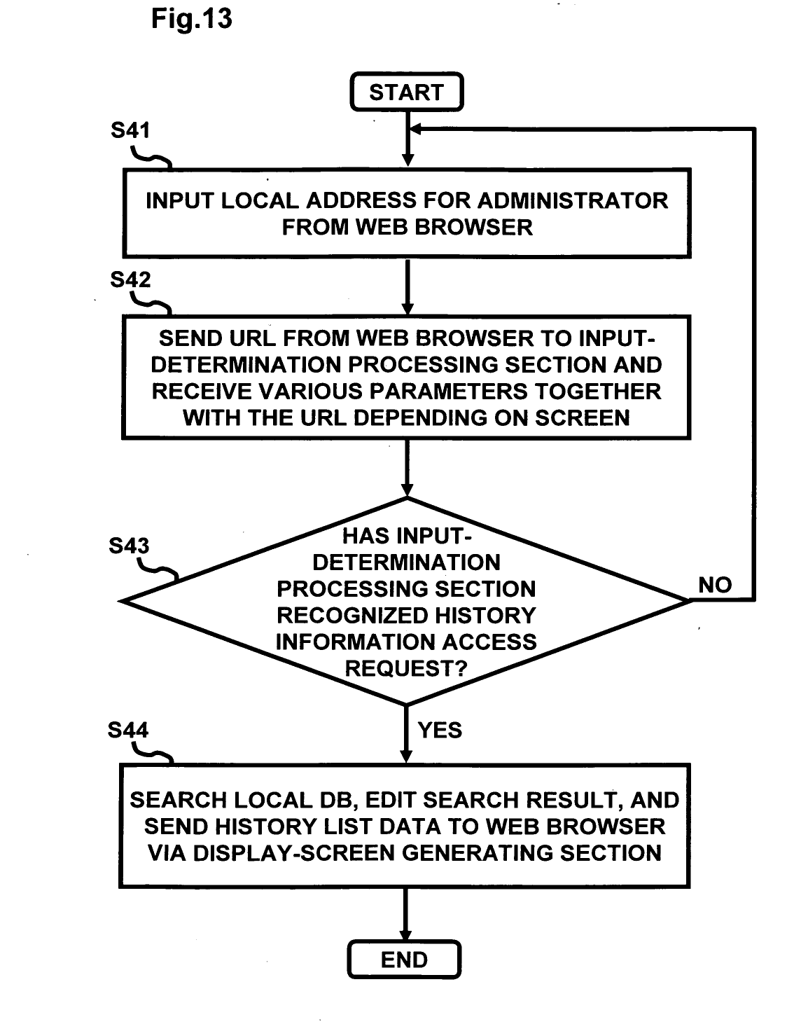

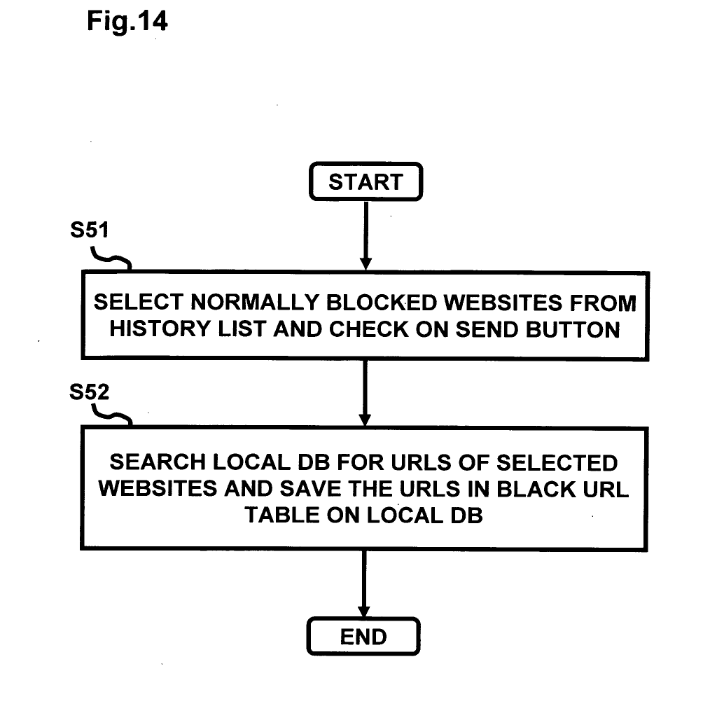

Referring to FIGS. 10, 11, 12, 13, and 14, the procedure for permitting or restricting access to a Website will be described. FIG. 10 is a flowchart of the overall procedure for permitting or restricting access to a Website. FIG. 11 is a flowchart for a procedure of accessing and filtering a Website. FIG. 12 is a flowchart for another procedure of accessing and filtering a Website. FIG. 13 is a flowchart for the procedure of viewing history information. FIG. 14 is a flowchart for the procedure of restricting access.

Referring to FIG. 10, the procedure for permitting or restricting access to a Website will be described. When the PC 2 receives a Website access request from the user (step S1), the PC 2 determines whether the requested Website is restricted. If it is restricted, a dialog screen and a warning message are displayed to inquire of the user whether he/she makes access (step S2). The dialog screen displays, if it is a restricted Website, the warning message 80 that the Website is restricted and the access is recorded and reported to the administrator. The user is thus given a good opportunity to reconsider the access to the Website by the warning message 80. As a result, if the user gives up the access to the Website, the procedure is completed. If the procedure moves to access, the user can access the Website and thus obtain necessary content (step S3). That is, the user can obtain desired information timely under the condition that the access is recorded and reported to the administrator.

When the user has moved to access, the PC 2 records its access (step S4), and sends the access record to the administrator using the report screen 88 (see FIG. 8) (step S5). The administrator boots up the PC 2, and shifts the report screen 88 to the browsing history check screen 98 (see FIG. 9) to allow check of the access record (step S6). Thus, the administrator can check the content of the browsing history check screen 98. Then, the PC 2 determines whether access to the Website is restricted (step S7), wherein when it is not restricted (step S7: NO), the Website can be accessed, so that the procedure moves to step S3, and when it is restricted (step S7: YES), the Website is blocked (step S8), and the administrator of the PC 2 gives a warning and an instruction to the user (step S9).

Referring to FIG. 11, the procedure for accessing and filtering Website will be described. The user inputs the URL of a desired Website using the Web browser 8 (step S11). The input URL is sent to the Web server 6 on the Internet 4 via the network communication section 14 (a in FIG. 1, step S12). The network communication section 14 receives the page data of the desired site from the Web server 6 (step S13). The network communication section 14 sends the page data to the filtering-determination processing section 18 (b in FIG. 1, step S14). The filtering-determination processing section 18 determines whether the received page data contains access denying keywords, that is, access denying keywords 72 on the access denying keyword table 50 of the local DB 12 (step S15). If the filtering-determination processing section 18 determines that the received page data contains no access denying keywords 72 (step S15: NO), the filtering-determination processing section 18 sends the page data to the Web browser 8, and permits access to the Website (c in FIG. 1, step S16).

If the filtering-determination processing section 18 determines that the received page data contains the access denying keywords 72 (step S15: YES), the filtering-determination processing section 18 stores the received page data, together with additional information (URL, date, etc.) in the browsing history table 48 which is the browsing history region of the local DB 12 (d in FIG. 1), thereby holding the page data (step S17). The filtering-determination processing section 18 sends data indicative of the warning message 80 on the dialog screen 78 (see FIG. 7) to the Web browser 8 via the display-screen generating section 16 (h in FIG. 1, step S18).

When the user clicks on the YES button 84 or the NO button 86 on the dialog screen 78 to select whether to access the Website (e in FIG. 1), the input-determination processing section 20 determines the input (step S19). If the input-determination processing section 20 determines that the input indicates access (the YES button 84 has been clicked on), the input-determination processing section 20 gives a display instruction to the filtering-determination processing section 18 (f in FIG. 1) to send the page data held in the browsing history table 48 to the Web browser 8, thereby permitting access to the Website (c in FIG. 1, step S20). The DB searching and editing section 22 searches through the data in the local DB 12, edits the search data, and stores the edited data in the local DB 12 (i in FIG. 1).

In contrast, if the input-determination processing section 20 determines that the input indicates no access (the NO button 86 has been clicked on), the input-determination processing section 20 sends non-display screen data to the Web browser 8 using the display-screen generating section 16, and blocks access to the Website (g in FIG. 1, step S21). In this case, the non-display screen may display “denied” as an indication that access has been denied.

In the procedure, the Web browser 8 determines whether to send the data to the Web server 6 according to whether the data indicative of whether to the Website can be accessed has an Internet address or a local address.

The local DB 12 has the white URL table 44 and the black URL table 46. Thus, in place of determination using access denying keywords, it is also possible that the URLs on the white URL table 44 and/or the black URL table 46 are compared with the URL of the desired Website, and when they match, the page is displayed (or not displayed). For example, as shown in FIG. 12, when the user inputs the URL of the Website (step S31), the input-determination processing section 20 determines whether the URL matches a URL on the black URL table 46 (step S32), wherein if they match (step S32: YES), the Website is blocked (step S33), and if they do not match (step S32: NO), the Website can be accessed (step S34).

Referring to FIG. 13, viewing of history information will be described. FIG. 13 is a flowchart of an example of the procedure for the administrator to view history information.

The administrator inputs a predetermined local address of the PC 2 for the administrator from the Web browser 8 (step S41). The Web browser 8 sends the URL to the input-determination processing section 20 and, depending on the screen, receives various parameter information together with the URL (step S42). The input-determination processing section 20 determines whether the received data has a history information access request (step S43). If the input-determination processing section 20 recognizes the history information access request (step S43: YES), the DB searching and editing section 22 searches the local DB 12 and edits the search results, and sends the history list data on the report screen 88 (see FIG. 8) to the Web browser 8 via the display-screen generating section 16 (step S44).

Referring to FIG. 14, the setting of restricted access (denied access) will be described. FIG. 14 is a flowchart of an example of the procedure for selecting restricted access from history information.

The administrator selects normally blocked Websites from the browsing history list 100 on the browsing history check screen 98 (see FIG. 9), and checks check boxes 120 corresponding to them, and clicks on the send button 122 (step S51). Upon reception, the input-determination processing section 20 searches the local DB 12 for the URLs of the selected Websites, and saves the URLs in the black URL table 46 on the local DB 12 (step S52). As a result, the Websites are blocked.

The features and advantages of the first embodiment will be listed below and its modifications will be given.
[1] If the user wishes to access the URL of Web content that is determined by the Web filtering function or set by the administrator to be undesirable, instead of unconditionally denying the access, the warning message 80, such as “Access to this Web content is restricted and is recorded and reported to the administrator.” “Do you wish to continue?”, is given. Thus, the user himself/herself can decide a risk that the browsing history is reported to the administrator. Accordingly, the effect of restricting access to undesirable sites serves as access filtering.
[2] Since the display of a warning message and the storage of the history are performed at the same time, access to undesirable sites can be restricted as in accessing the sites in front of the administrator. If the user selects “access”, the browsing history information is stored using the Web filtering function, for which the basic function of the Web browser 8 can be used in the first embodiment without additional special function.
[3] The administrator can freely check the history information. Accordingly, if the user wishes to access an undesirable site, the administrator can give a warning and an instruction, and block the undesirable site using the access deny registration function, thus completely blocking further access.
[4] Since user's Website browsing history is automatically stored, the administrator can easily view the stored information, allowing the administrator to check any time what content the user viewed.
[5] If the browsing history contains an undesirable site, the administrator can add the information on the site to the denied Website list to block it. Thus, the undesirable site or content in the undesirable site can be blocked without checking.
[6] A user's access request is accepted under the condition that the access is recorded and/or reported to the administrator. Accordingly, if the user wishes to access Website content that is blocked by filtering software, the user can view the Website content without the involvement of the administrator to obtain necessary information.
[7] Since Website browsing history is automatically stored, the administrator can easily view the stored information, preventing the user from accessing undesirable content.
[8] Awareness about the standard of undesirable sites can be met between the user and the administrator, so that user's Internet literacy can be improved. Particularly, when the user is under age, decision on harmfulness can be made through communication with user's parents.
[9] Not only unconditional block of access but also restriction or cancellation of access to undesirable sites by user's decision can be made. Furthermore, access to undesirable Websites can be mentally prevented. The filtering system can protect children and young people from undesirable Websites and Web content through the mediation of user's decision while respecting user's originality.

### Second Embodiment

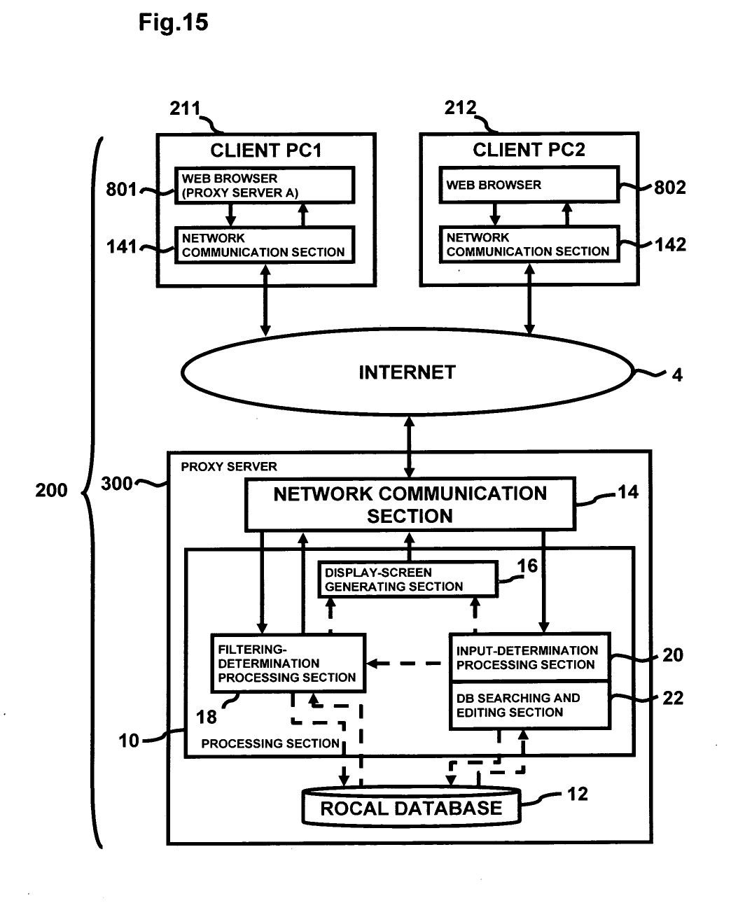

Referring to FIG. 15, a second embodiment of the invention will be described. FIG. 15 is a diagram of a PC network system according to the second embodiment. In FIG. 15, the same components as those of FIG. 1 are given the same reference numerals.

In the first embodiment, the PC 2 that is a user terminal is configured as a filtering apparatus, and is shared by the user and the administrator. In the second embodiment, a proxy server 300 has the filtering function so that the filtering function as in the first embodiment is achieved by the proxy server 300.

The PC network system 200 is a network system in which PCs 211 and 212, such as client PCs 1 and 2, and the proxy server 300 are networked via the Internet 4. The PC 211 includes a Web browser 801 and a network communication section 141. The PC 212 includes a Web browser 802 and a network communication section 142. The proxy server 300, like the PC 2 (see FIG. 1), includes the processing section 10, the local DB 12, and the network communication section 14.

This configuration can also prevent unrestricted access to an undesirable Website responding to a user's request under the condition that the access is recorded and reported to the administrator, and improve the Internet literacy of the user.

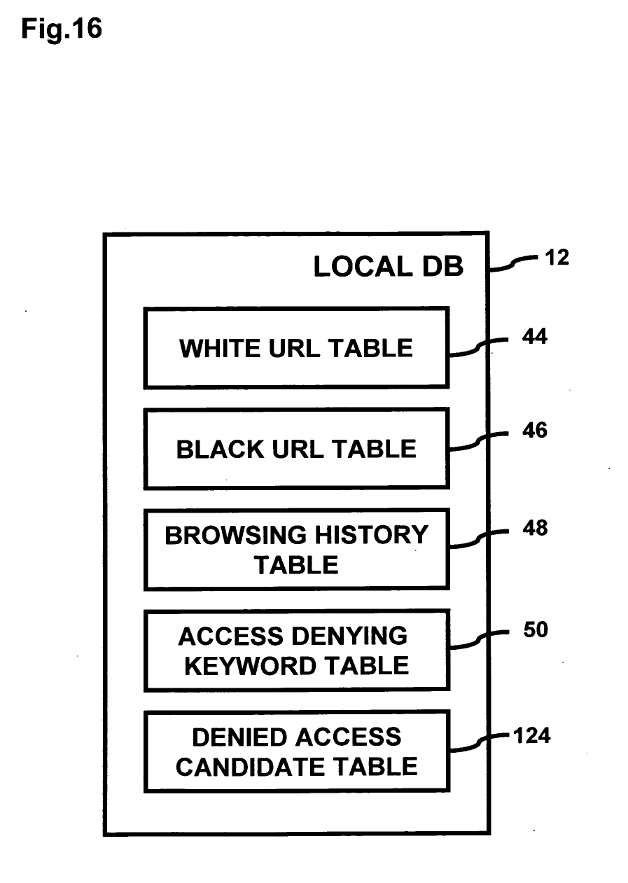

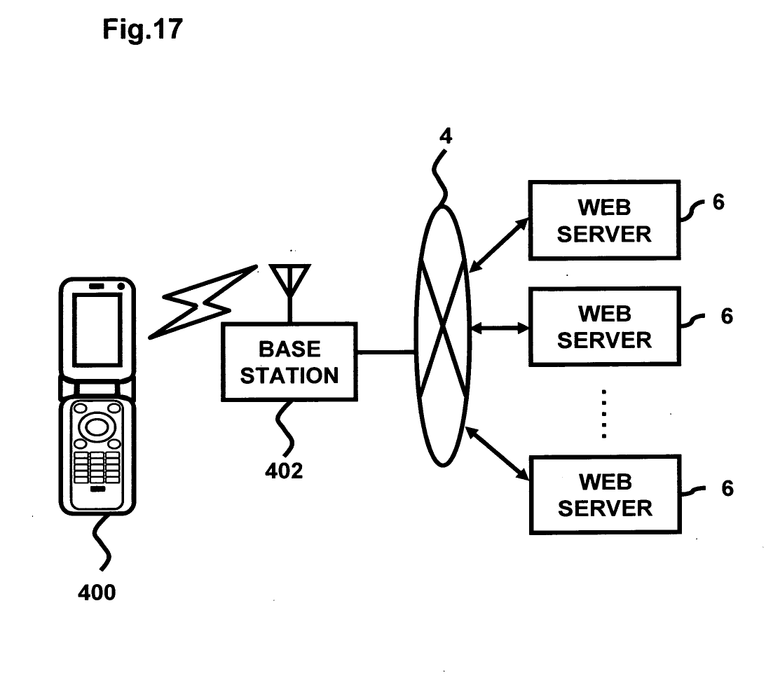

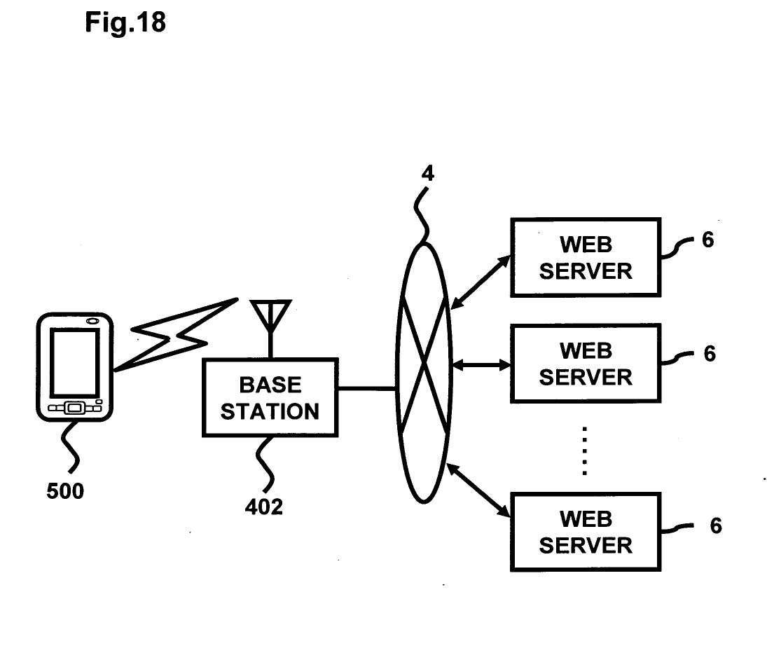

### Other Embodiments

[1] The local DB 12 of the above embodiments may further have a denied access candidate table 124, as shown in Fig. 16, in which an blocked site candidate list is added, and at the next access, information on undesirable sites may be presented to the user or, a conversation with the user about the harmfulness of the Website may be given so that the user can add the undesirable site to the blocked URL list of the black URL table 46 according to the user's own decision. The configuration of registering restriction according to user's own decision improves the Internet literacy of the user.
[2] In the above embodiments, browsing history is added on the screen of the PC 2. Instead, it may be informed to the mobile terminal of the administrator, such as a PC or a mobile phone by e-mail using the communications function of the PC 2.
[3] In the above embodiments, the blocking of access is set on the browsing history check screen using a common PC or another PC. Instead, the blocking of access and the checking of browsing history may be made by remote control using the remote control function of a mobile terminal such as a PC or a mobile phone.
[4] In the above embodiments, the PC 2 is taken as an example. Instead, as shown in FIG. 17, a mobile terminal 400 such as a mobile phone may be used. In this case, the mobile terminal 400 is connected to the Web servers 6 via a base station 402 using a radio communication function. Such a configuration can also prevent unrestricted access to undesirable sites responding to a user's request under the condition that the access is recorded and/or reported to the administrator.
[5] As shown in FIG. 18, a personal digital assistant (PDA) 500 may be used. In this case, the PDA 500 is connected to the Web servers 6 via the base station 402 using a radio communication function. Such a configuration can also prevent unrestricted access to undesirable sites responding to a user's request under the condition that the access is recorded and/or reported to the administrator.
[6] In the above embodiments, an access request is accepted under the condition that the access is recorded and/or reported to the administrator. Instead, it may be accepted under the condition that the access is recorded or reported to the administrator.
[7] In the above embodiments, the PC 2, the mobile terminal 400, and the PDA 500 are taken as examples of a device capable of accessing Websites. It is to be understood that the invention is not limited to those devices and can be applied to any devices having communications capability and that can obtain content from Websites.

The foregoing embodiments provide the following advantages:
[1] When the user viewed a restricted Website, the administrator can be informed of what Website the user viewed from one or both of the access record and its record.
[2] When the user gives a request to access a restricted Website, the user is informed of the condition that the access is accepted when the access is recorded and/or reported to the administrator. This makes the user realize the intention of the administrator again and gives a good opportunity to reconsider the access to the undesirable Website, which prevents access to undesirable Websites, thus improving the availability of Web content.

The above and other objects, features, and advantages of the invention will be more apparent from the accompanying drawings and the embodiments.

What is claimed is:

1. An information processing apparatus for restricting accesses of websites, the information processing apparatus comprising:
a storage unit for storing information of access restricted websites; and
a processor for performing a process of access permission comprising the steps of:
receiving a request of access to one of the websites from a user;
determining whether the requested websites is restricted or not by reference to the stored information of the access restricted websites;
warning the user when the request has been made for the access to one of the restricted websites; and
permitting the access to said one of the restricted websites upon confirmation of the warning by the user and reporting the access of the restricted websites to an administrator.

2. The information processing apparatus according to claim 1,
wherein the storage unit stores a black URL table containing URLs of impermissible websites and
when the processor determines that an access request by the user is made to a URL of one of the impermissible websites stored in the black URL table, the processor prohibits the access to the requested websites regardless of the user's confirmation.

3. The information processing apparatus according to claim 1,
the processor for performing the process of access permission further comprising the steps of:
generating a message for warning the user when the request has been made for the access to one of the restricted websites.

4. The information processing apparatus according to claim 1,
the processor for performing the process of access permission further comprising the steps of:
generating a dialog screen for receiving a response for the warning from the user.

5. The information processing apparatus according to claim 1,
the processor for performing the process of access permission further comprising the steps of:
accepting a prohibition of the access of websites from the administrator which receives the report of the access of the restricted websites.

6. A method for restricting accesses of websites executed by a processor comprising the steps of:
receiving a request of access to one of the websites from a user;
determining whether the requested websites is restricted or not by reference to information of the access restricted websites;
warning the user when the request has been made for the access to one of the restricted websites; and
permitting the access to said one of the restricted websites upon confirmation of the warning by the user and reporting the access of the restricted websites to an administrator.

7. The method according to claim 6, further comprising the steps of:
generating a message for warning the user when the request has been made for the access to one of the restricted websites.

8. The method according to claim 6, further comprising the steps of:
accepting a prohibition of the access of websites from the administrator which receives the report of the access of the restricted websites.
